(19) United States
(12) Patent Application Publication
(10) Pub. No.: US 2014/0314995 A1
(43) Pub. Date: Oct. 23, 2014

(54) PULSED LASER PROCESSING METHOD FOR PRODUCING SUPERHYDROPHOBIC SURFACES

(71) Applicant: IMRA AMERICA, INC., Ann Arbor, MI (US)

(72) Inventors: Bing LIU, Ann Arbor, MI (US); Yuki ICHIKAWA, Aichi (JP)

(73) Assignee: IMRA AMERICA, INC., Ann Arbor, MI (US)

(21) Appl. No.: 14/323,431

(22) Filed: Jul. 3, 2014

Related U.S. Application Data
(63) Continuation of application No. PCT/US2013/065456, filed on Oct. 17, 2013.
(60) Provisional application No. 61/717,266, filed on Oct. 23, 2012.

(51) Int. Cl. B23K 26/00

(52) U.S. Cl. CPC B23K 26/0084; B23K 26/009
USPC 428/141; 264/400; 427/596; 427/597; 427/554; 118/624; 425/174.4; 219/121.72

(57) ABSTRACT

A method of pulsed laser processing of solid surface for enhancing surface hydrophobicity is disclosed wherein the solid surface is covered with a transparent medium during laser processing and the laser beam incidents through the covering medium and irradiates the solid surface. Two effects are obtained simultaneously. One is the laser-induced texture formation directly under the laser irradiation. The other is the deposition of the laser-removed materials along the laser scan lines. Both effects introduce surface roughness on nanometer scales, and both enhance surface hydrophobicity, rendering superhydrophobicity on the surfaces of both the laser-irradiated solid and the covering medium. Because the beam scan line spacing can be larger than a single scan line width by multiple times, this method provides a high processing speed of square inch per minute and enables large area processing.

This application is a continuation of international application number PCT/US2013/065456, filed 17 Oct. 2013 and designating the US, which claimed priority from U.S. Provisional Application 61/717,266, filed Oct. 23, 2012. The contents of the prior applications are incorporated herein by reference.

### FIELD OF THE INVENTION

The present invention relates to solid surface processing with a pulsed laser to alter the surface physical and chemical properties, and more particularly to produce surface textures and surface coatings such that the processed surface exhibits a superhydrophobic property.

### BACKGROUND

The following publications relate to, among other things, the formation of superhydrophobic surfaces, surface texturing, coating of surfaces, and/or laser based pattern generation:

### PUBLISHED PATENT APPLICATIONS

Bhushan et al, U.S. Patent Appl. Pub. No. 2006/0078724;
Shen et al., U.S. Patent Appl. Pub. No. 2006/0079062;
Gupta et al., U.S. Patent Appl. Pub. No. 2010/0143744;
Liu et al., U.S. Patent Appl. Pub. No. 2010/0227133;
Aria, U.S. Patent Appl. Pub. No. 2011/0250376;
Kato et al., U.S. U.S. Patent Appl. Pub. No. 2012/0121858.

### Other References 1-18

[1] X.-M. Li, D. Reinhoudt, and M. Crego-Calama, Chem. Soc. Rev., 2007 Vol. 36, pp 1350.
[2] K. Teshima, H. Sugimura, Y. Inoue, 0. Takai and A. Takano, Appl. Surf. Sci., 2005, Vol. 244, pp 619.
[3] S. Minko, M. Muller, M. Motornov, M. Nitschke, K. Grundke, and M. Stamm, J. Am. Chem. Soc., 2003, Vol. 125, 3896.
[4] Z. Yoshimitsu, A. Nakajima, T. Watanabe and K. Hashimoto, Langmuir, 2002, Vol. 18, pp 5818.
[5] K. Y. Suh and S. Jon, Langmuir, 2005, Vol 21, pp 6836.
[6] W. Lee, M. K. Jin, W. C. Yoo and J. K. Lee, Langmuir, 2004, Vol. 20, pp 7665.
[7] E. Martines, K. Seunarine, H. Morgan, N. Gadegaard, C. D. W. Wilkinson and M. O. Riehle, Nano Lett., 2005, Vol. 5, pp 2097.
[8] M. Hikita, K. Tanaka, T. Nakamura, T. Kajiyama and A. Takahara, Langmuir, 2005, Vol. 21, pp 7299.
[9] J. Y. Shiu, C. W. Kuo, P. L. Chen and C. Y. Mou, Chem. Mater., 2004, Vol. 16, pp 561.
[10] Y. Li, W. P. Cai, B. Q. Cao, G. T. Duan and F. Q. Sun, Polymer, 2005, Vol. 46, pp 12033.
[11] M. H. Jin, X. J. Feng, L. Feng, T. L. Sun, J. Thai, T. J. Li and L. Jiang, Adv. Mater., 2005, Vol. 17, pp 1977.
[12] J. E. Sipe, J. F. Young, J. S. Preston, and H. M. Vandriel, Phys. Rev. B. 1983, Vol. 27, pp 1141.
[13] T. Baldacchini, J. E. Carey, M. Zhou, and E. Mazur, Langmuir, 2006, Vol. 22, pp 4917.
[14] R. Jagdheesh, B. Pathiraj, E. Karatay, G. R. B. E. Romer, and A. J. Huis in't Veld, Langmuir, 2011, Vol. 27, pp 8464.
[15] D. H. Kam, S. Bhattacharya and J. Mazumder, J. Micromech. Microeng. 2012, Vol. 22, pp 105019.
[16] A.-M. Kietzig, S. G. Hatzikiriakos, and P. Englezos, Langmuir, 2009, Vol. 25, pp 4821.
[17] Liangliang Cao, Andrew K. Jones, Vinod K. Sikka, Jianzhong Wu, and Di Gao, Langmuir 2009, 25(21), 12444-12448
[18] Shutao Wang and Lei Jiang “Definition of superhydrophobic states”, Adv. Materials, 2007, 19, 3423-3424.

### SUMMARY OF THE INVENTION

In one aspect the present invention provides a fast laser processing method for producing superhydrophobic surfaces.

At least one embodiment provides a method of pulsed laser processing for producing superhydrophobic surfaces on solid(s). A surface of a workpiece is covered with a transparent covering medium. A pulsed laser beam passes through the covering medium and irradiates the workpiece surface. The method can provide simultaneous dual effects of laser induced surface roughening and nanoparticle coating of the workpiece surface, and further provide nanoparticle deposition/coating on the covering medium surface. The method also significantly reduces any laser scan line density requirement such that the line spacing can be much wider than the line width, for example at least about ten times, thereby greatly improving throughput.

In at least one embodiment, prior to laser processing, the workpiece surface is coated with a thin layer of commonly available hydrophobic material such as a non-polar polymer. Thus, with such a pre-processing step, the solid workpiece to be laser processed includes the pre-coated surface. Laser processing of the pre-coated workpiece is carried out in the same manner as in the above exemplary embodiment, for example, by covering the polymer surface with a transparent medium and focusing the laser through the covering medium and onto the workpiece. In this way, dual effects are obtained, including laser roughening of the polymer, and coating of nanoparticles comprised of the hydrophobic pre-coating material on the surface of both the pre-coated workpiece and the transparent covering medium.

In at least one embodiment, the covering medium is selectively coated with hydrophobic materials removed by laser irradiation from an underlying hydrophobic solid such as a non-polar polymer, such that arrays of superhydrophobic areas are created on the covering medium, which can originally be of a hydrophilic material such as glass.

In any or all embodiments, by utilizing a high pulse repetition rate of at least a few hundred KHz, and more preferably in the MHz range, for example in the range from 1 MHz to about 10 MHz, a fast laser processing speed of several square inches per minute can be achieved. In some embodiments rates of up to a few hundred MHz may be achievable. The method can be performed in ambient conditions, and does not require toxic or corrosive chemical agents, and is versatile so as to allow user-designed patterns.

### BRIEF DESCRIPTION OF THE DRAWINGS

FIG. 1 schematically illustrates water-solid contact angles. (a) Water on a flat hydrophilic surface, (b) Water on a flat hydrophobic surface, (c) Water on a rough hydrophobic surface as in the Wenkel's model, and (d) Water on a rough hydrophobic surface as in the Cassie and Baxter model.

FIG. 2 schematically illustrates a laser processing arrangement in accordance with an embodiment of the present invention.

FIG. 3 shows optical images of stainless steel samples processed with a method and system according to the present invention. (a) A matrix of patches processed with various laser scan line spacing and scan speed, exhibiting different gray scales. (b) Sprayed water on the sample. Note that the water droplets stay only on the unmarked lines and their intersections because the water droplets are repelled away from the laser processed patches that have become superhydrophobic. (c) An optical shadowgraph of a water droplet sitting on a superhydrophobic sample.

FIG. 4 shows scanning electron microscopy images of laser processed samples. (a) Two laser scan lines with 60 μm line spacing. The width of a laser scan line is about 12 μm. Note that there is a gray belt of deposits of about 20 μm wide accompanying the laser scan line. (b) Magnified image of a laser scan line. (c) Increased magnification image of the edge of a laser scan line, showing particle deposits on the edge. (d) High resolution imaging revealing the deposits to be nanoparticles.

FIG. 5 schematically illustrates of the portion of a workpiece and covering medium near the laser focus during ablation, with laser plasma (plume) expanding sideways because of the confinement by the covering medium, and the deposits remaining along the scan lines on both the cover medium and the workpiece surface.

FIG. 6 schematically illustrates surface morphology created by laser processing according to an embodiment. W=laser scan line width; D=deposit width; S=laser scan line spacing.

FIG. 7 shows scanning electron microcopy images of laser produced deposits on a glass used as the covering medium. (a) Low magnification image. (b) High magnification image showing lines of deposits. Note that on the image of coated glass, the darker stripes are the laser scan lines and the brighter granular stripes are the deposits.

FIG. 8 illustrates an embodiment of the current invention in which a pre-coating layer, preferably comprising a hydrophobic material, is applied to the workpiece surface prior to laser processing. Thus, as a result of the pre-processing step, the solid workpiece to be laser processed includes the pre-coated surface After laser processing, the pre-coated surface is covered by deposits of nanoparticles comprising the materials of the pre-coating layer.

FIG. 9 illustrates scanning electron microscopy images of laser-processed surface of a polymer (polyethylene) that has been applied as the pre-coating layer on the surface of an aluminum plate, as in the manner described with respect to FIG. 8. (a) Low magnification image. (b) High magnification image showing particle deposits along the laser scan lines.

FIG. 10 schematically illustrates a checker board laser marking pattern where only the line-filled patches are to be scanned by laser beam and the blank patches are to remain unprocessed.

FIG. 11 illustrates an aluminum plate covered with a pre-coating of polyethylene and processed by laser as in the embodiment described with respect to FIG. 8, and using the checker board marking pattern as illustrated in FIG. 10.

FIG. 12 illustrates (a) an optical image and (b) a schematic illustration showing water droplets on glass fabricated with selectively coated superhydrophobic areas. The droplets remain only on hydrophilic patches and are confined by the surrounding superhydrophobic patches.

FIG. 13 schematically illustrates an after-coating layer, preferably comprising a hydrophobic material, applied to a workpiece surface after laser processing.

### DETAILED DESCRIPTION OF THE INVENTION

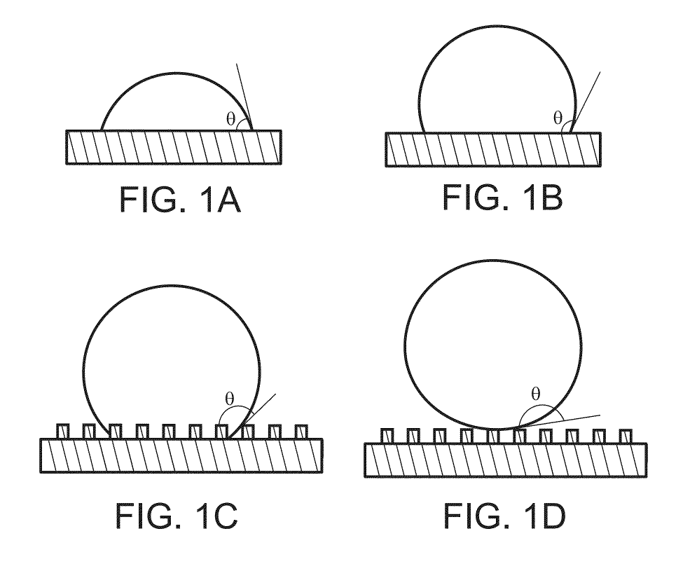

As generally defined in various references and known in the art, a surface is termed hydrophilic when water forms flat droplets with a shallow contact angle of less than 90°, and hydrophobic when water forms more spherical droplets with a steeper contact angle of greater than 90°, as illustrated in FIGS. 1(a) and 1(b), respectively. When the contact angle is greater than 150°, the surface is generally regarded as superhydrophobic. However, pointed out in Kato et al. (2012/0121858, [0002]-[0003]), no scientific definition of a superhydrophobic surface has been established and the term refers to a surface exhibiting a water contact angle of 150 degrees or more which is significantly difficult to wet. As discussed therein, water contact angle of about 120 to 150 degrees is referred to as a highly hydrophobic surface, with an ordinary hydrophobic surface exhibiting a water contact angle of about 90 to 120 degrees. Aria et al. (2011/0250376, [0003]) points out that a superhydrophobic surface is extremely difficult to wet; it typically has a static contact angle higher than 150 degrees and a contact angle hysteresis less than 10 degrees. Thus, as used herein a superhydrophoic surface, or a surface exhibiting superhydrophobic properties, is a flexible term and not constrained by the exact contact angle of 150 degrees as a threshold. For example, the contact angle may be measured with different approaches yielding results which differ about the 150 degree angle. Superhydrophobic properties may also be exhibited at somewhat shallower angles, for example angles near 150 degrees but within the measurement tolerance of a shadowgraph or other instrument, or angles somewhat greater than about 120 degrees, for example. One aspect of a superhydrophobic surface is strong water repelling properties of the surface. Further discussion of superhydrophobic states as known in the art may also be found, for example, in Wang et al. [Ref 18].

Control of surface wetting properties is desired for many applications. For example, a superhydrophobic surface can be self-cleaning, anti-frosting and anti-icing, and also exhibits superior tribology properties. The field of biological and medicinal examination will also benefit from low cost sample plates (often glass slides) that can have regular arrays of defined hydrophilic areas to contain the liquids to be examined. One approach is to fabricate superhydrophobic patterns on a hydrophilic medium such that a hydrophilic area with superhydrophobic surroundings can act as a planar liquid container.

Nature has provided many examples of superhydrophobic surfaces such as lotus leaves and butterfly wings. The self-cleaning effect helps lotus and butterflies survive in their high humidity living environments. Close examination of such surfaces reveal high densities of asperities with dimensions between nanometer to micrometer scales. Wenkel in 1936 first explained such hydrophobicity as a result of surface roughness, where a large liquid-solid contact area is balanced with a steep liquid-solid contact angle, as illustrated in FIG. 1(c). Cassie and Baxter in 1944 further considered the role of air trapping by a rough surface and provided a model that explained the phenomenon of superhydrophobicity. As illustrated in FIG. 1(d), a rough surface with high densities of asperities or protrusions can trap air in the valleys, effectively decreasing the solid-liquid contact area and increasing the air-liquid contact area (which has an 180° contact angle by definition). Equation 1 expresses the effective contact angle θ on a rough surface in the Cassie-Baxter model:

cos θ=fₛ cos θ_{S-L}+fₛ−1 (Eq. 1)

where θ_{S-L} is the liquid contact angle on an ideal flat surface, and fₛ is the fraction of the solid-liquid contact area in the total contact area on a rough surface. Given a negative value of cos θ_{S-L}, which initially corresponds to a moderately hydrophobic flat surface, by further reducing the factor fₛ, the cos θ value can reach nearly −1. This in turn renders a very high contact angle of θ close to 180°, and therefore superhydrophobicity. The fundamentals of surface wettability are reviewed in detail, for example in, Ref. 1 cited above.

In practice, there have been numerous surface processing methods for producing surface roughness that satisfies Eq. 1. The approaches can be divided into two categories of either material removal, for example by physical etching or lithography, or material addition for example by surface coating. Examples of the material removal approach include plasma etching [Ref. 2, 3], micromachining [Ref. 4], and lithography that can produce regular asperities according to a predesign [Ref. 5-7]. In the material addition approach, examples include coating the surface with colloidal particles [Ref. 8-10] and nanotubes [Ref. 11]. Combinations of surface patterning and coatings are taught in US Pub. No. 2006/0078724, where predesigned arrays of asperities are first produced on the surface, and a layer of commonly available hydrophobic material, for example fluorocarbon, is applied subsequently to achieve superhydrophobicity. The strategy of this approach is to satisfy the low fₛ factor in Eq. 1 and the negative θ_{S-L} in Eq. 1 separately by the predesigned roughness and the subsequent coating of commonly available hydrophobic materials, respectively.

In the field of laser material processing, it is known that pulsed laser ablation of a solid surface can produce ripple-like periodic surface patterns with sub-wavelength length scales, rendering the surface with roughness on the same scales. This phenomenon has been explained as a result of interference between the incident laser beam and surface scattered waves [Ref. 12]. Short pulse duration in the regime of picosecond to femtosecond is preferred for producing this effect due to less heat generation. Also, the effect is more pronounced when the laser fluence (defined as pulse energy averaged over the area of focal spot) is just slightly above the ablation threshold. By combining with a chemical etching gas, such laser surface texturing technique has produced highly roughened surfaces on silicon that have very low light reflection (thus giving the name black silicon) which are also superhydrophobic [Ref. 13]. This method is also taught in U.S. Patent App. Pub. No. 2006/0079062 to Mazur et al. Laser surface texturing and the consequent superhydrophobicity can also be achieved in ambient air, as demonstrated in Ref. [14-16], and taught in US Patent App. Pub. No. 2010/0143744 to Gupta et al.

In all of the above cited examples of laser-induced surface roughening, the solid surface was fully covered by the laser scan in order to produce superhydrophobicity. Full coverage of the surface by laser scan requires a very high scan line density such that the line spacing is equal or less than the line width (equal to focal spot size), resulting in a very low processing speed. Furthermore, in several of above methods, the laser-made asperities are large conical shaped pillars of micron scale [Ref. 13, 15] which require a long time exposure to laser irradiation to produce, which further slows the process. Ref. 16 demonstrated an interesting case of laser-induced superhydrophobicity on very shallow surface ripples produced by limiting the laser irradiation time, but the surface needs to be exposed to ambient air or CO₂ gas for at least several days after the laser processing to initiate superhydrophobicity.

US patent App. Pub. No. 2010/0227133 ('133) is assigned to the assignee of the present invention. The '133 publication teaches a method of laser printing on a transparent medium where the medium, for example a glass slide, is placed adjacent to or in contact with a target. An incident laser beam is transmitted through the medium and ablates the target, depositing the ablated material on the medium.

During an experiment with the above '133 method it was surprisingly discovered that both the target workpiece and the transparent cover medium became superhydrophobic after the laser printing process. Additional experimentation ensued and further results were obtained as exemplified in the embodiments and examples which follow.

As discussed above, FIG. 1 schematically illustrates four exemplary scenarios of water contact angle on solid surface, where Eq. 1 summaries the relationship between the water contact angle θ and the factor fₛ, defined as the fraction of solid-liquid contact area in the total contact area on a rough surface.

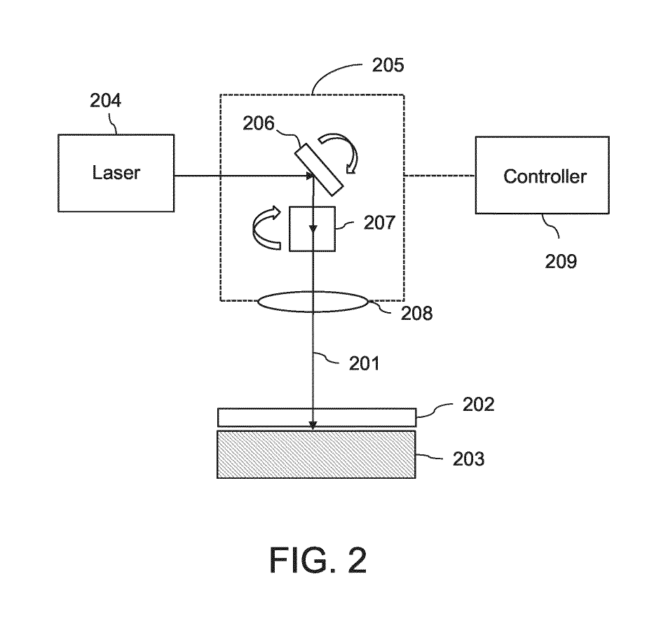

FIG. 2 shows an exemplary laser processing arrangement. Laser beam 201 is generated by the laser 204. The incident beam passes through a covering transparent medium 202 and is preferably focused on the surface of a workpiece 203. The laser pulse duration is preferably in the range from about 100 femtosecond (fs) to 1 nanosecond (ns). The workpiece 203 material can include metals (stainless steel, aluminum, copper etc.), metal alloys, semiconductors, plastics, and/or other suitable materials. In some embodiments the workpiece may be coated or otherwise modified prior to laser processing, as will be discussed below. The covering medium 202 can comprise materials that are transparent to the laser wavelength, including glass, quartz, plastics, and etc. The covering medium 202 can be placed directly on top of the workpiece 203, which will leave a natural gap in the range around 0.1-10 μm depending on the native roughness of the workpiece surface. Alternatively the gap between the covering medium and the workpiece can be adjusted using spacers. The cover medium effectively acts as an optical window for the incident laser beam and is used to affect the laser interaction as well, as will be discussed below. The overlying covering medium 202 arrangement is not a necessary restriction, the geometric arrangement may be modified based on particular laser processing application requirements, for example, a geometric configuration with a laser beam incident in a horizontal rather than vertical direction may be utilized in some embodiments. In general, the covering medium will be adjacent and closely spaced to the workpiece, for example placed within a distance from about 0.1 micrometer to 1 mm from the workpiece surface, or in direct contact with the workpiece.

Scanning of the beam is achieved with a beam scanner 205, which may include two vibrating mirrors 206 and 207 for beam scanning in perpendicular directions. The beam is focused with a lens 208, which preferably is an f-theta lens to preserve flatness of the scan field. Parameters such as scan speed (also known as marking speed) and line spacing (also known as pitch) are controlled by the controller 209. In some embodiments a programmable scanning system, for example based on X-Y galvanometers, may be used to generate geometric scan patterns other than line scans. For example, circular or elliptical patterns may be generated.

IMRA America Inc., the assignee of the present application, disclosed and supplies several fiber-based laser systems which utilize chirped pulse amplification (FCPA). The systems are capable of providing a high repetition rate ranging from 0.1 MHz to above 1 MHz, an ultrashort pulse duration ranging from 500 femtosecond to a few picoseconds, and a high average power ranging from 1 W to more than 10 W. This type of FCPA system, particularly when operated at high repetition rates, is suitable for use in various preferred embodiments. Other high-repetition pulsed laser arrangements may be used in various embodiments and may comprise fiber and/or bulk solid state lasers. In various preferred embodiments an available pulse width may be in the range from 10 fs up to 1 ns, 100 fs-100 ps, or less than 1 ps. A minimum pulse energy may be about 100 nJ, with maximum energy up to about 1 mJ, or in the range from about 100 nJ to 100 μJ. An adjustable output pulse repetition rate may be in the range of 1 KHz to 10 MHz, or more preferably from at least several hundred (300) KHz to 10 MHz. In operation the laser beam diameter may be about 5-6 mm. The beam can be expanded to larger size for tighter focus. The focal spot size (which determines scan line width) may be in the 10-60 μm range. In some embodiments the spot size may be increased to increase throughput, for example from about 60 μm up to a few hundred μm, or in the range from about 60-300 μm, while achieving superhydrophobic performance. Many possibilities exist depending on the particular application requirements.

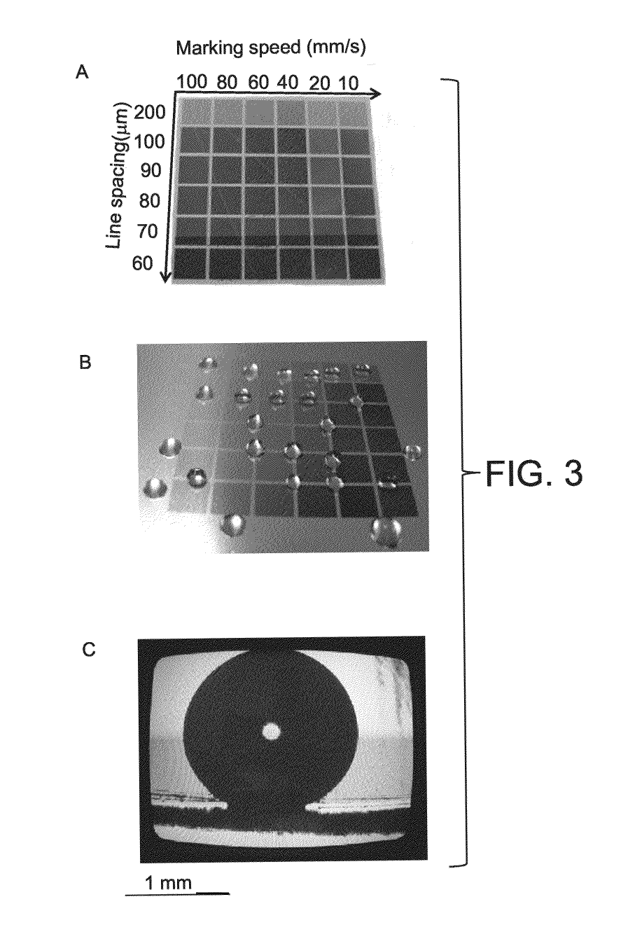

FIG. 3(a) is an image of a stainless steel sheet processed with a method of the current invention. A test matrix of 6×6 patches each of 8×8 mm² were formed with line spacing varying from 60 μm to 200 μm, and marking speed varying from 10 mm/s-100 mm/s. Each patch required processing time of about 10-20 seconds.

FIG. 3(b) shows water sprayed on the processed sample. During water spraying the water droplets quickly rolled away from the laser-processed patches, and remained only on the intersections of the grids that were not processed by the laser, thereby demonstrating the superhydrophobicity of the laser-processed patches.

FIG. 3(c) is an optical shadowgraph showing a water droplet sitting on the sample. In this example, a large contact angle greater than 150° was measured from the optical shadowgraph. It was also observed that superhydrophobicity can be achieved with laser scan line spacing up to 300 μm and with scan speed (also called mark speed) up to 2 m/s. Such processing speeds are well above conventional systems used to produce superhydrophobic surfaces. In some embodiments a laser beam scan speed can be varied between about 0.001 m/s to 10 m/s, with scan line spacing in a range between about 0.01 to 1 mm.

Surprisingly, if one considers that water still contacts the unprocessed areas between the scan lines, and assuming very small contact on the scanned lines, the factor fₛ is determined by the complement of the ratio of line width (W) to line spacing (S), as given by, fₛ=1−W/S. Such fₛ, ranging from 0.5 to 0.9, is too large for Eq. 1 to explain the observed superhydrophobicity.

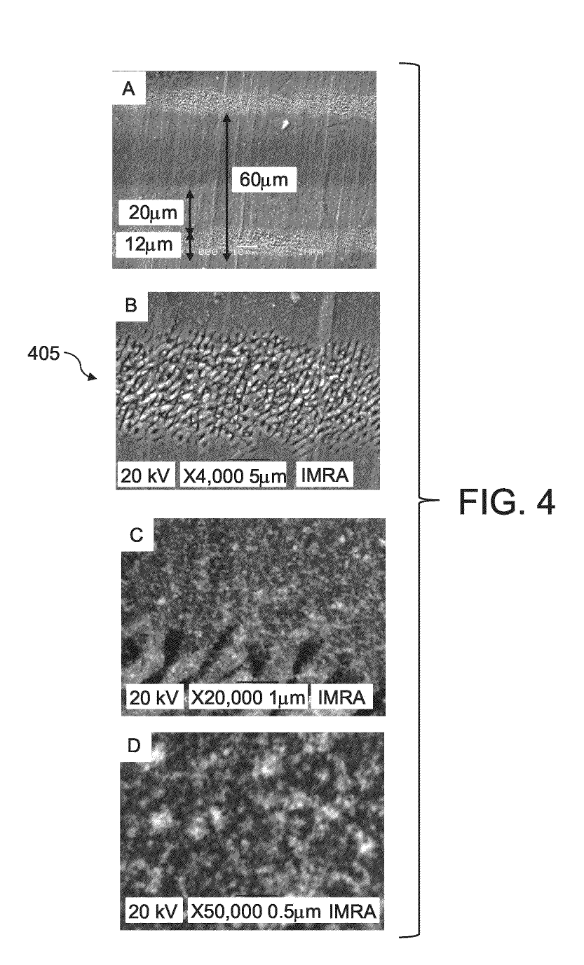

The sample workpiece surface was examined in more detail, as shown in FIG. 4. Overall, the surface may be characterized by having at least two distinct features. One such feature is a microstructure originating from the scanning movement of the laser spot during laser texturing. Other features include nano-size fine particles, which are produced by laser ablation and are distributed following the microstructure pattern. FIG. 4(a) is a scanning electron microscope (SEM) image showing two neighboring scanned lines with a line width of 12 μm and line spacing of 60 μm. A gray belt of about 20 μm wide is seen accompanying the bottom line. FIG. 4(b) shows a magnified view of the textured morphology 405 of the laser scanned lines. It is well-known that parallel ripples can be produced on a solid surface by pulsed laser ablation near (and above) the ablation threshold and the ripple directions are perpendicular to the laser polarization. The rugged morphology in the example FIG. 4(b) is a result of the multiple reflections between a stainless-steel workpiece surface 203 and the covering medium 202. The multiple reflections alter the beam polarization, resulting in the broken ripples. Detailed morphology of the gray belt observed in FIG. 4(a) along the bottom line edge is displaced in high resolution images of FIGS. 4(c) and 4(d), revealing that the gray belt comprises fine particles of 10-100 nm in size. Such fine particles may exhibit further interesting properties. For example, It was demonstrated by Cao et al. [ref 17] that the existence of sub-100 nm particles on a surface produces an anti-icing effect. In particular, from FIG. 3 of the Cao reference it can be seen that “icing probability” approaches zero with nanoparticle size below about 100 nm. Surface deposits formed in accordance with various laser processing embodiments described herein may exhibit such behavior.

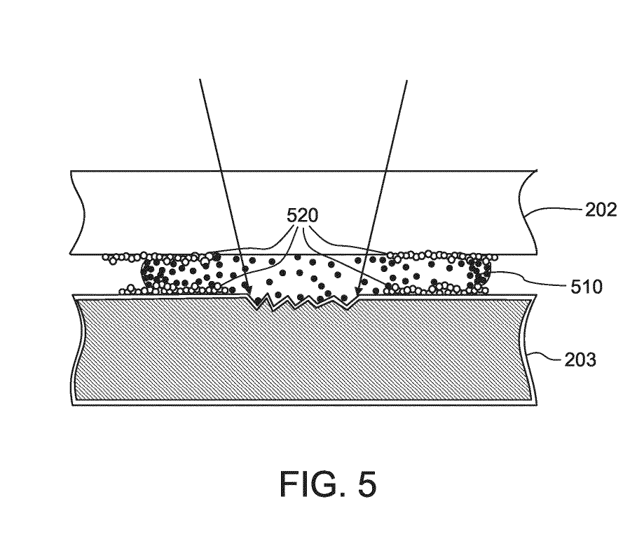

Although it is not necessary to the practice of embodiments of the present invention to understand the underlying operative mechanism thereof, based on these observations, the authors believe the overall surface morphology produced by the laser processing method in the current invention is a result of space-confined laser ablation, as illustrated in FIG. 5. By covering the workpiece 203 surface with a transparent (e.g.: glass) medium, expansion of the laser induced plasma 510 (also known as plume, represented by black dots) is confined in the vertical direction and forced sideways, leaving deposition of the laser removed materials along either side of the laser scan line. As evident from FIG. 5, deposits 520 (white dots) are formed on the glass medium 202 and the workpiece 203, which may be referred to as medium deposits and workpiece deposits, respectively. Laser induced microstructures are formed on the workpiece at or near the laser-workpiece interaction region where workpiece material is removed. Therefore laser-processed workpiece surfaces are partly covered by laser-produced ripples, and partly covered by the deposits, both contributing to the enhanced surface roughness. The nearly-periodic ripples, or other non-periodic or random structures, are representative of micro-scale or nano-scale features resulting from the processing, and particularly with laser processing pulses in the femtosecond to picosecond range. For example, suitable pulse width ranges include from about: 10 fs-1 ns, 10 fs-1 ps, 100 fs-50 ps, or up to a few hundred ps, and preferably provide for high definition surface texturing with low heat affected zone, melting, or other thermal processing effects which could degrade the surface texture or coating quality.

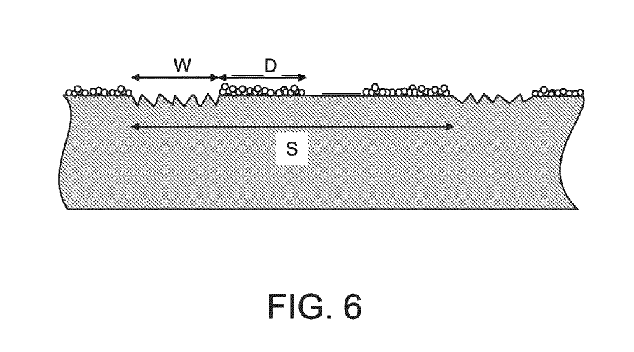

It can be seen from FIGS. 5 and 6 that material removed from the workpiece with the laser (e.g.: plume 510) forms workpiece deposits on the workpiece and forms medium deposits on the covering medium. A portion of said workpiece from which material is removed and a portion of the workpiece deposits collectively induce a superhydrophobic property at the workpiece. At the medium, a portion of the medium deposits collectively induce a superhydrophobic property at said covering medium.

As illustrated in FIG. 6, where the line spacing S can be equal or greater than the sum of laser scan line width W and twice of the deposition width D, i.e., S≧W+2D, enabling a very high processing speed of up to several square inches per minute, for example at least 0.25, 0.5, 1, 2, or 5, square inches per minute, and up to about 10 square inches per minute depending on the scan density. By way of example, the line spacing may be at least about 3-times, 5-times, or up to 10-times the focused width of a scan line. As discussed above, in some embodiments scan patterns other than rectilinear raster scans may be generated, for example elliptical, circular, spiral or other patterns. A ratio of a non-scanned area to a scanned area may be up to about 10-times. Similarly, spacing between arbitrary scan portions may be up to about 10-times wider than a focused beam width.

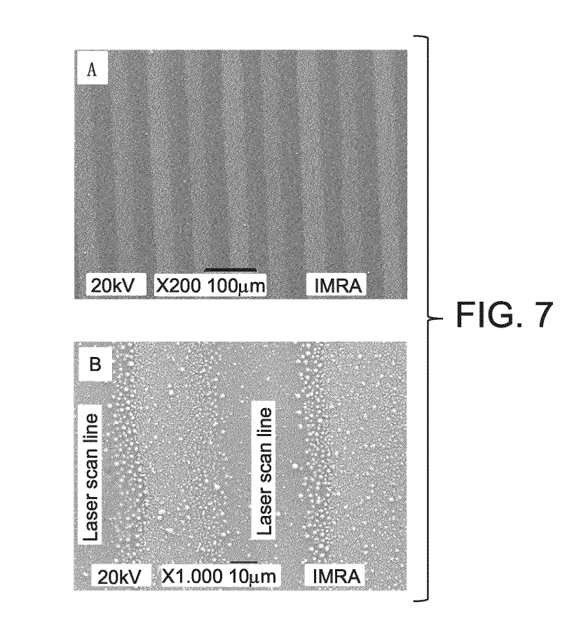

FIG. 7 shows a low magnification (a) and high magnification (b) SEM images of lines of deposits on the covering medium surface. Note that on the covering medium, the deposits accumulate along the laser scan lines.

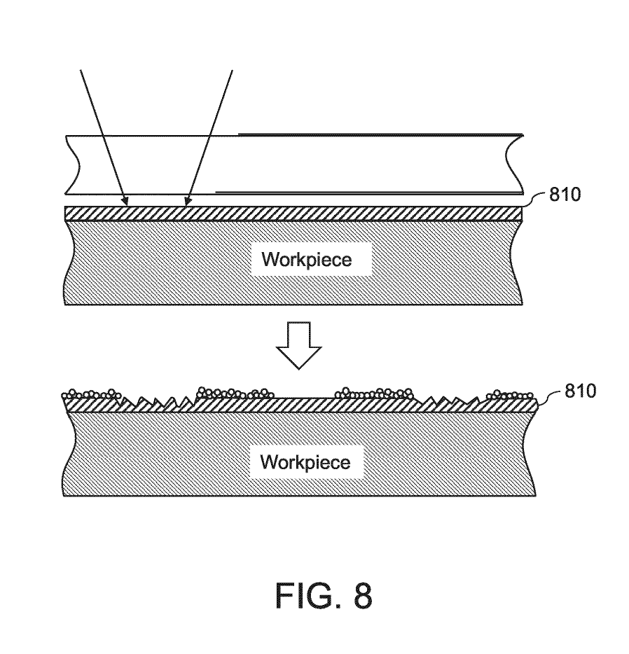

FIG. 8 illustrates a variation in which a pre-coated layer 810 is applied on the workpiece surface before laser processing in an otherwise identical processing arrangement. Thus, as a result of the pre-processing step, the solid workpiece to be laser processed includes the pre-coated surface. The pre-coated material can be a commonly available hydrophobic material (e.g., waxes or non-polar or weakly polar polymers, etc.) to ensure that laser produced deposits comprise hydrophobic materials. This pre-coated layer is to introduce superhydrophobicity on those workpiece materials that are not very hydrophobic, for example many metals and oxides, or even on hydrophilic materials. Laser processing of the workpiece, as described above, is carried out subsequent to pre-coating.

Water surface tension at room temperature is 72 mN/m. Most commonly available non-polar or weakly polar polymers are hydrophobic with surface tension in the range between 18 mN/m and 50 mN/m, much lower than the surface tension of water. These polymers include most hydrocarbons, thermoplastics, fluorocarbons, and elastomers. These polymers can all be applied as the pre-coating layer. The coating methods can include mechanical spin coating, spray coating, lamination, or more complex chemical coating methods such chemical vapor deposition.

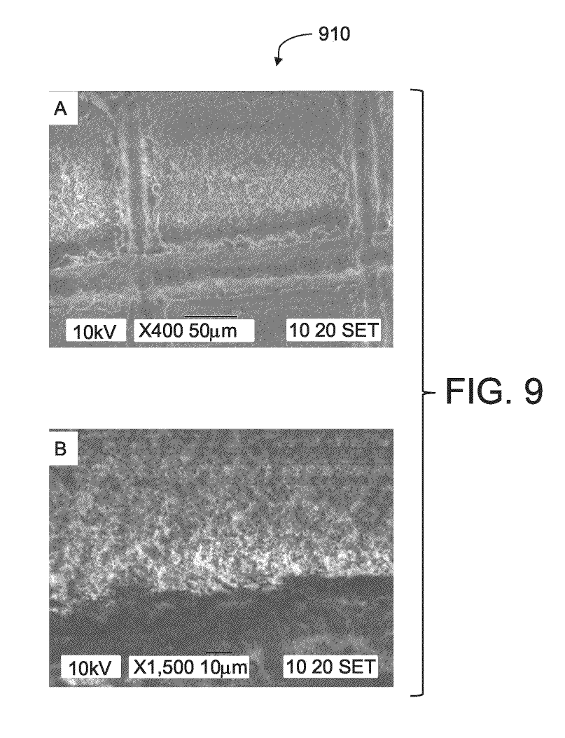

FIG. 9 shows two SEM images of a pre-coated layer of polyethylene (PE) after laser processing in the manner described with respect to FIG. 8. The low magnification image of FIG. 9(a) shows the grid pattern with line spacing of 150-200 μm, and the high magnification image of FIG. 9(b) shows the particle deposits along a portion of the laser scan line.

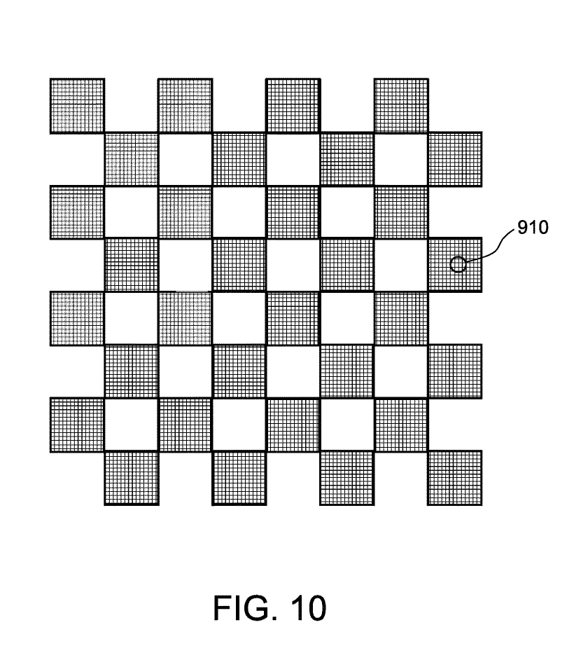

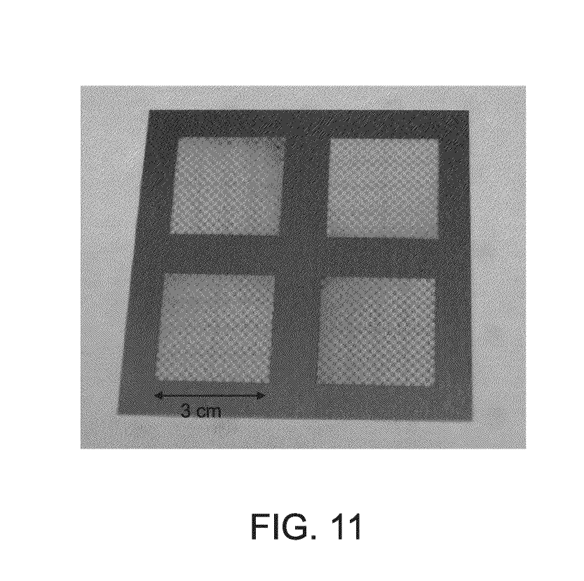

To further speed up the process, various geometric patterns may be utilized, such as the checkerboard pattern shown in FIG. 10, where only the filled patches are scanned by the laser and the blank patches are unprocessed. For example, we found that the dimension of each single patch can be large as 3×3 mm² without affecting the overall superhydrophoic properties of the laser-processed workpiece. For the purposes of illustrating the scale of operation, region 910 corresponds approximately to the processed region in the SEM image of FIG. 9. FIG. 11 further shows an aluminum plate of 10×10 cm² processed in the manner described with respect to FIG. 8 using a checkerboard laser scan pattern, where a layer of polymer PE is first applied on the aluminum plate before the processing. Notably, the processed regions of FIG. 11 were formed with a dense scan pattern similar to that illustrated in FIG. 10, and thus with slower throughput than obtained with the rectilinear raster scans as, for example, illustrated in the example FIG. 3a. Notably, each of the four laser-processed squares was 3×3 cm² and required a processing time of only 1 min., or total processing time of about 4 minutes. Thus, high throughput was achievable.

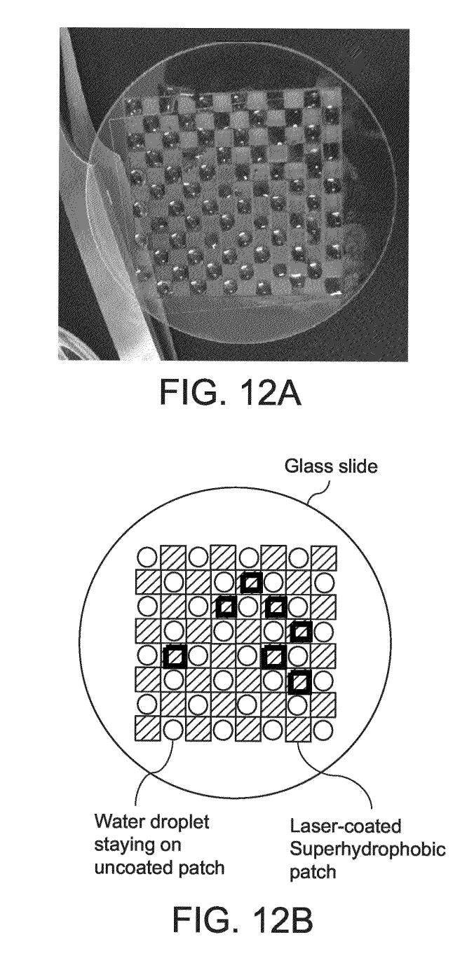

Regarding the effects of processing on the covering medium, when using such a scan pattern with arrays of scanned and blank areas, we found that only the areas that directly face the laser-scanned patches (e.g., the filled patches in FIG. 10) were coated with particles removed by the laser from the underlying polymer and became superhydrophobic. The areas facing the unprocessed blank patches remain uncoated and keep their original water wetting properties. For example, uncoated glass remains hydrophilic. FIG. 12(a) shows an example of a 2″ glass slide fabricated with an array of superhydrophobic patches (each 3×3 mm²) using a hydrophobic polymer (PE) as the underlying solid for laser ablation. Water droplets stay only on the uncoated areas that are confined by the superhydrophobic patches. This provides a simple way of producing arrays of superhydrophobic patterns on a hydrophilic medium, as schematically illustrated in FIG. 12(b). It is to be understood that the pattern is not limited to checkerboard, and other suitable patterns may be implemented, for example regular or irregular pattern shapes, periodic or aperiodic, or combinations thereof.

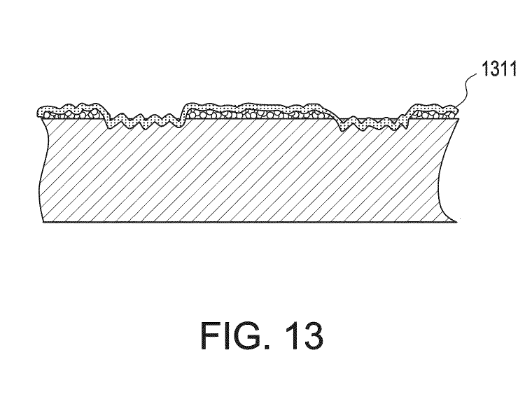

FIG. 13 illustrates yet another variation in which an after-coating layer 1311 is applied to the workpiece surface after the laser processing. By way of example, the workpiece surface texture is preferably created with laser processing as described herein followed by application of a moderately hydrophobic after-layer. The purpose of this layer can be to induce or enhance the superhydrophobicity and also to act as a protecting layer. The after-coating materials can be wax or polymers.

For purposes of summarizing the present invention, certain aspects, advantages and novel features of the present invention are described herein. It is to be understood, however, that not necessarily all such advantages may be achieved in accordance with any particular embodiment Thus, the present invention may be embodied or carried out in a manner that achieves one or more advantages without necessarily achieving other advantages as may be taught or suggested herein.

Thus, the invention has been described in several embodiments. It is to be understood that the embodiments are not mutually exclusive, and elements described in connection with one embodiment may be combined with, or eliminated from, other embodiments in suitable ways to accomplish desired design objectives.

We claim:

1. A method of pulsed laser processing for producing a superhydrophobic surface on a workpiece comprising a solid, said method comprising:
irradiating said workpiece with a pulsed laser beam to remove a portion of material from said workpiece, wherein said irradiating comprises:
transmitting said pulsed laser beam through a covering medium that is transparent at said laser wavelength and disposed between a source of the pulsed laser beam and said workpiece, said covering medium disposed adjacent to said workpiece; and
scanning and focusing said pulsed laser beam relative to said workpiece,
wherein material removed from said workpiece forms workpiece deposits on said workpiece and forms medium deposits on said covering medium in such a way that a portion of said workpiece from which material is removed and a portion of said workpiece deposits collectively induce a superhydrophobic property at said workpiece, and a portion of said medium deposits collectively induce a superhydrophobic property at said covering medium.

2. The method of claim 1, wherein a source of said pulsed laser beam generates pulses having a pulse duration in the range from about 100 femtosecond to a few hundred picoseconds.

3. The method of claim 1, wherein a source of said pulsed laser beam generates pulses having a pulse energy in the range from about 100 nJ to 1 mJ.

4. The method of claim 1, wherein a source of said pulsed laser beam generates pulses having at a repetition rate from about 1 kHz to 10 MHz.

5. The method of claim 1, wherein a source of said pulsed laser beam generates pulses at a repetition rate in the MHz range.

6. The method of claim 1, wherein said covering medium is placed directly on a solid surface of said workpiece and in contact with said solid surface.

7. The method of claim 1, wherein said covering medium is placed within a distance from about 0.1 micrometer to 1 mm from said workpiece.

8. The method of claim 1, wherein said covering medium comprises glass, quartz, and plastic.

9. The method of claim 1, wherein said workpiece comprises a metal.

10. The method of claim 9, wherein said metal comprises stainless steel, aluminum, or copper.

11. The method of claim 1, wherein said workpiece comprises a hydrophobic material.

12. The method of claim 11, wherein said hydrophobic material comprises hydrocarbon polymer, thermoplastic polymer, fluorocarbons, or elastomers.

13. The method of claim 1, wherein said scanning and focusing produces a ratio of non-scanned area to a scanned area up to about 10.

14. The method of claim 13, wherein a superhydrophobic property is induced at a non-scanned workpiece locations.

15. The method of claim 1, wherein said scanning and focusing forms scan lines having a spacing in a range from about 0.01 to 1 mm.

16. The method of claim 15, wherein a superhydrophobic property is induced at a non-scanned workpiece location in said spacing between scan lines.

17. The method of claim 1, wherein a laser beam scan speed is variable between about 0.001 m/s to 10 m/s.

18. The method of claim 1, wherein said workpiece further comprises: a pre-coating layer, said pre-coating layer being formed on said workpiece surface before said irradiating.

19. The method of claim 18, wherein said pre-coating layer comprises a hydrophobic material.

20. The method of claim 19, wherein said hydrophobic material comprises wax, hydrocarbon polymer, thermoplastic polymer, fluorocarbons, or elastomers.

21. The method of claim 1, wherein an after-coating layer is applied to the said work piece surface after said irradiating.

22. The method of claim 21, wherein said after-coating layer comprises a hydrophobic material.

23. The method of claim 22, wherein said hydrophobic material comprises wax, hydrocarbon polymer, thermoplastic polymer, fluorocarbons, or elastomers.

24. The method of claim 1, wherein said scanning is carried out over pre-selected areas of said workpiece.

25. The method of claim 24, wherein said pre-selected areas form a regular pattern.

26. The method of claim 24, wherein said pre-selected areas exhibit superhydrophobic behavior as a result of said pulsed laser processing, and at least one non-selected area adjacent to a pre-selected area exhibits low resistance to wetting.

27. The method of claim 1, wherein said superhydrophobic surface is characterized by having a liquid-solid contact angle of at least about 150 deg.

28. The method of claim 1, wherein said step of irradiating produces said workpiece deposits and said medium deposits, and further forms a surface texture on said workpiece, said surface texture characterized by having laser induced surface micron-scale or nano-scale structure, wherein said deposits and said structure(s) increase the roughness of a surface of said workpiece.

29. The method of claim 28, wherein said workpiece deposits and said medium deposits comprise nanoparticles.

30. A laser based system comprising: an ultrashort pulsed laser source and a beam scanner configured to carry out a method of pulsed laser processing for producing a superhydrophobic surface as claimed in claim 1.

31. A product comprising a surface having a superhydrophobic property made according to the method of claim 1.

32. A medium having a coated surface portion formed with a laser processing method according to claim 1.
